(19) United States
(12) Patent Application Publication
(10) Pub. No.: US 2010/0147834 A1
(43) Pub. Date: Jun. 17, 2010

(54) Method for Induction Heating of a Metallic Workpiece

(75) Inventors: Werner Witte, Unna (DE); Peter Bilstein, Menden (DE)

Correspondence Address: EDELL, SHAPIRO & FINNAN, LLC, 1901 RESEARCH BOULEVARD, SUITE 400, ROCKVILLE, MD, 20850, US

(73) Assignee: ZENERGY POWER GMBH, Rheinbach (DE)

(21) Appl. No.: 12/714,714

(22) Filed: Mar. 1, 2010

Related U.S. Application Data
(63) Continuation of application No. PCT/EP2008/006716, filed on Aug. 14, 2008.

(30) Foreign Application Priority Data
Oct. 24, 2007 (DE) 102007051108.8

(51) Int. Cl. H05B 6/06

(52) U.S. Cl. 219/650

(57) ABSTRACT

A method for induction heating of a metallic workpiece to a desired temperature by rotating the workpiece relative to a direct-current magnetic field permeating the workpiece is provided. The workpiece is clamped between two clamping jaws adapted to be rotated about a common axis. At least one of the clamping jaws is driven to rotate, and at least one of the clamping jaws is adapted to be actively displaced along or parallel to the rotation axis. The contact force of at least one of the clamping jaws is regulated; moreover, at least one mechanical parameter representative of the workpiece temperature is measured as an actual value and is compared with a desired value of this mechanical parameter as being representative of the desired temperature.

### CROSS REFERENCE TO RELATED APPLICATIONS

This application is a continuation of International Application No. PCT/EP2008/006716, filed on 14 Aug. 2008, entitled “Method for Inductive Heating of a Workpiece,” which claims priority under 35 U.S.C. §119 to Application No. DE 102007051108.8 filed on 24 Oct. 2007, entitled “Method for Inductive Heating of a Workpiece,” the disclosures of which are hereby incorporated by reference in their entireties.

### FIELD OF THE INVENTION

The present invention relates to a method for induction heating of a metallic workpiece to a desired temperature by moving the workpiece relative to a magnetic field permeating the workpiece.

### BACKGROUND

Metallic workpieces, in particular in the form of bars, ingots, billets/blooms, or rods, can be heated in a magnetic field that is excited by means of at least one coil, the winding of which carries either an alternating current or a direct current. In the first case, the workpiece is usually at rest in the alternating-current magnetic field, but it can also be subjected to translational or rotational movement relative to this. In the latter case, i.e. when a direct-current magnetic field is excited, a translational and/or rotational relative movement between the magnetic field and the workpiece is necessary.

A basic difficulty of known methods for induction heating of moving workpieces is determining the time-dependent rising temperature of the workpiece with sufficient and reproducible accuracy in order to terminate the heating process when a prescribed desired temperature has been attained. Although direct contact measurements (e.g., direct measurements utilizing a thermo-couple) yield very precise measurement values, they are not practical because these measurements can be performed only on a workpiece at rest. While indirect contact measurements (e.g., measurements of the temperature-dependent resistance of the workpiece material) can be performed on a moving workpiece, they require sliding contacts, which not only are subject to wear, but also lead to very inaccurate measurement results because of layers of oxide and scale on the surface of the workpiece. This disadvantage is also present in a conventional method for measuring the temperature of an induction-heated roll by measuring the roll diameter.

Although non-contacting measurements (e.g., those performed by pyrometry) can be carried out in a substantially simple manner, they do not yield any sufficiently accurate and reproducible measurement results because they are based on a calculation that converts measured IR radiation to corresponding black-body temperatures utilizing correction factors. The correction factors which express the emissivity of the material used in relation to a black body, however, are dependent not only on the material, but also on the condition of the surface of the workpiece. The condition of the surface is, in turn, considerably temperature-dependent, particularly owing to oxide or scale formation. Therefore, the emissivity can change considerably to increase and decrease between room temperature and the desired temperature. For example, with copper, the emissivity increases from about 0.3 at room temperature to about 0.7 at 600° C. as a result of the formation of black copper oxide. On the other hand, with aluminum, the emissivity drops with increasing temperature due to the formation of white aluminum oxide.

Independently from this, extruded blocks may have a surface condition that already differs from block to block before the heat treatment. Therefore, in many cases even a pyrometric measurement of the actual temperature of a workpiece is not sufficiently accurate and, as such, does not yield reproducible values from workpiece to workpiece.

### SUMMARY

The present invention is directed toward a method that makes it possible to heat a metallic workpiece by induction to a desired temperature with sufficient and reproducible accuracy. In particular, the present invention is directed toward a method for induction heating of a metallic workpiece to a desired temperature by rotating the workpiece relative to a direct-current magnetic field permeating the workpiece. The workpiece is clamped between two clamping jaws adapted to be rotated about a common axis. At least one of the clamping jaws is driven to rotate; moreover, at least one of the clamping jaws is adapted to be actively displaced along or parallel to the rotation axis. The contact force of at least one of the clamping jaws is regulated. In addition, at least one mechanical parameter representative of the workpiece temperature is measured as an actual value and is compared with a desired value of this mechanical parameter as being representative of the desired temperature.

### BRIEF DESCRIPTION OF THE DRAWINGS

FIG. 1 illustrates a device for induction heating of a workpiece to a desired temperature by measuring the thermal expansion of the workpiece.

FIG. 2 illustrates a device for induction heating of a workpiece to a desired temperature by measuring the mechanical work supplied to the workpiece.

Like reference numerals have been used to identify like elements throughout this disclosure.

### DETAILED DESCRIPTION OF THE INVENTION

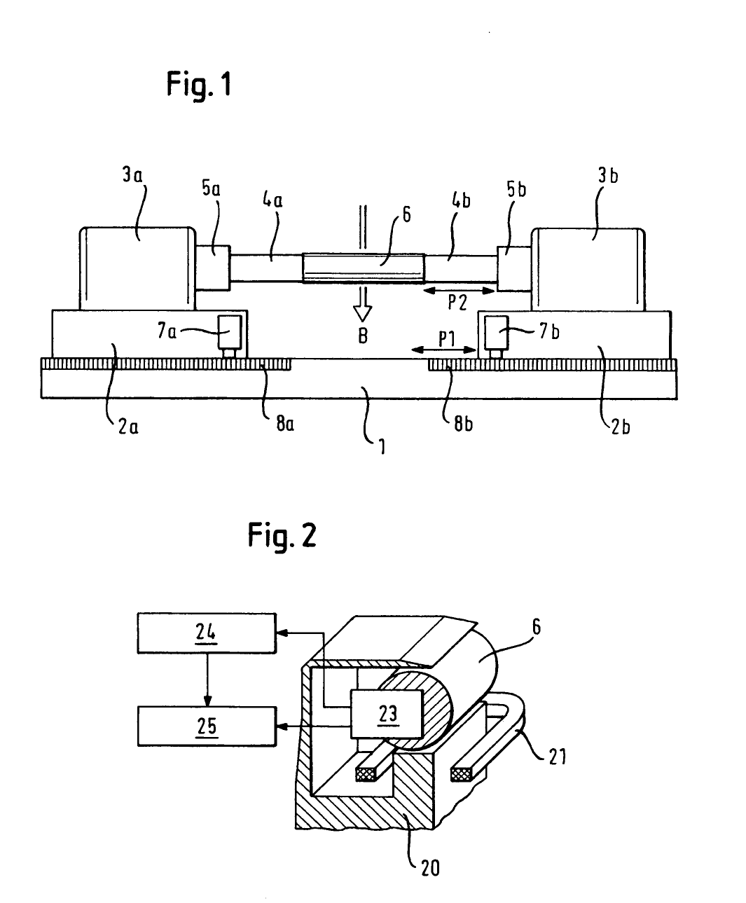

In FIG. 1 two carriages 2a, 2b that are spaced from each other are disposed on a machine bed. At least one of these carriages is adapted to be moved along the direction of the double arrow P1 by means of a not depicted drive means. Each of the carriages 2a, 2b carries an electric motor 3a and 3b, respectively. Each electric motor 3a or 3b drives a clamping jaw 4a or 4b, respectively. At least one of the clamping jaws 4a, 4b is adapted to be moved in accordance with the double arrow P2 relative to the respective electric motor 3a, 3b by means of a hydraulic device 5a, 5b. A workpiece in the shape of a cylindrical bar 6 is clamped between the clamping jaws. The bar 6 is permeated by a magnetic field which is indicated by the arrow B and is generated by a direct-current carrying coil (not illustrated).

Each of the carriages 2a and 2b carries a path-measuring sensor 7a and 7b, respectively. These path-measuring sensors measure the position of a respective carriage relative to the machine bed 1 by scanning the indicated linear measuring sales 8a or 8b, respectively, and consequently the changing, temperature-dependent length of the bar 6 between the clamping jaws 4a, 4b. Instead of the path-measuring sensors 7a or 7b as illustrated, any other path or distance measuring means operating with sufficient accuracy can also be used. In particular, a laser distance-measuring means that measures the distance between the carriages 2a and 2b directly, or a laser distance-measuring means that measures the distance between the end faces of the clamping jaws 4a and 4b directly and transmits the measurement data by radio to a receiving means also can be used.

FIG. 2 shows a device for induction heating with which the temperature of the workpiece 6 is determined from the work supplied to the latter. The workpiece 6 rotates between the pole pieces of an iron core 20 of a coil 21 which may include a superconducting winding. The workpiece 6 is set into rotation via an indicated driving motor 23 (in principle in analogy with FIG. 1, i.e. supported between clamping jaws and, if necessary, also via two driving motors). The torque transmitted from the driving motor 23 to the workpiece 6 is transmitted by means of sensing elements, e.g. wire strain gauges disposed on the shaft, as an electrical signal to a processing unit 24 which supplies a parameter proportional to torque to the process computer 25. The process computer furthermore receives a signal, e.g., a signal derived from the driving motor 21, which is representative of the rotation number of the workpiece 6. As soon as the rotation number is different from zero, a time measurement is started in the computer. From the rotation number, the torque, and the elapsed heating time the computer determines the work supplied to the workpiece. In the computer the actual value of the quantity of the work is compared with a stored desired value, and in the case of equality the driving motor 23, for example, is stopped.

The desired value or a number of desired values are measured as sensed values for each workpiece dimension and each workpiece material on a similar or identical workpiece that is heated by induction, preferably in the same way (for example, by repeatedly interrupting the heating by stopping the drive, and via contact with a thermocouple, or by performing a calibrated pyrometric measurement on a moving workpiece).

Thus, the above described invention is directed toward a method for induction heating of a metallic workpiece to a desired temperature by rotating the workpiece relative to a direct-current magnetic field permeating the workpiece. In addition, the method provides that at least one mechanical parameter representative of the workpiece temperature is measured as an actual value and is compared with a desired value of this mechanical parameter as being representative of the desired temperature.

In a regular case, the induction heating is discontinued when the actual value has attained the desired value.

Preferably, the actual value of the representative mechanical parameter is measured as a proportional electrical signal, or is converted to an electrical signal of this kind, the magnitude of which is then compared with the magnitude of an electrical signal corresponding to the desired value. For example, for documentation purposes, the actual value can be continuously measured and stored.

Preferably, the desired value representative of the desired temperature is determined on a reference workpiece of the same kind which is induction heated according to the same method, with its temperature and the corresponding actual value of the mechanical parameter being determined, and also the value of the mechanical parameter that is measured upon attainment of the desired temperature being treated as a desired value for all workpieces of the same kind.

It is particularly simple to use the thermal expansion of the workpiece as a representative mechanical parameter. This thermal expansion can be measured by means of a direct or indirect measurement of path. This can be achieved in a non-contacting or contacting manner. Because the thermal expansion is proportional to an initial value of the measured dimension of the workpiece at the starting temperature, in the case of an elongated workpiece, e.g. a billet or a bar, a measurement of its thermal expansion along its longer axis is attended by less measurement effort than a measurement along its shorter axis, such as for example a measurement of the diameter in the case of a cylindrical workpiece.

A substantially anisotropic uniformity of the desired temperature of the workpiece is ensured when clamping jaws of poor thermal conductivity are used.

When the desired temperature is within the temperature range in which the material of the workpiece begins to become plastically deformed in dependence upon the pressure exerted on the surface, the contact force is regulated in dependence upon the temperature to a value corresponding to a surface pressure that is smaller than the temperature-dependent surface pressure at which this plastic deformation of the workpiece begins. Thereby it is ensured that the spacing between the clamping jaws increases proportionally to the increase of temperature of the workpiece as long as the coefficient of expansion remains constant regardless of temperature. This applies to most workpieces with sufficient accuracy.

Particularly when the contact force of the clamping jaws is produced hydraulically and the value of the contact force is determined from the value of the hydraulic pressure, the value of the contact force can be very simply reduced, if need be, by lowering the hydraulic pressure.

The contact force of the clamping jaws, effected for example by a linear displacement of one of the rotatable clamping jaws, can be set or regulated also with a linear motor, a spindle drive or a rack-and-pinion drive.

As the representative mechanical parameter, the mechanical work supplied to the workpiece also can be used instead of the thermal expansion.

Because in the case of a rotatably driven workpiece the mechanical work depends upon the transmitted torque amongst other factors, it is expedient to measure continuously at least the torque transmitted to the workpiece.

With a constant rotation number, the mechanical work then can be calculated from this rotation number, the measured torque, and the time.

If, on the other hand, the workpiece is rotatably driven at different rotation numbers whilst being heated, the mechanical work is calculated from the time-integral of this time-dependent rotation number and the time-dependent torque. The torque can be calculated from the active current or the active power of the converter of the motor characteristic. This and other methods for continuous torque measurement are familiar to a person skilled in the art.

As a rule, the temperature determined from the thermal expansion is attended by a smaller error than the temperature determined from the mechanical work. It is therefore preferred to use the temperature determined from the mechanical work only for a plausibility check of the temperature of the workpiece as determined from the thermal expansion.

The proposed method is expediently performed by process control. For this, particularly the reference values, although measured with effort but with precision on the reference workpiece, and the actual values of the mechanical parameter measured on the workpieces, can be continuously stored in a process controller which compares the actual values measured on the workpieces during the induction heating with the stored reference values and emits a signal representative of the actual temperature. On the basis of this signal that can be displayed as an analog or digital value, for example on a screen, the operating personnel can read the calculated actual temperature of the workpiece. However, the signal can be used, in particular, to terminate the heating operation automatically as soon as the actual temperature has reached the desired temperature.

A further development of this method consists in that the reference values for workpieces of different dimensions and/or for workpieces of different materials are stored in separate data files. For workpieces of changing dimensions and/or of different materials, which in the latter case as a rule also must be heated to different desired temperatures, the process control is in this case restricted to calling-up the respective relevant data file and the desired temperature, either by hand or, with completely process-controlled systems, automatically from workpiece and/or material data transmitted by a higher-ranking process controller.

Additionally, if the mechanical work is used as a parameter representative of the workpiece temperature, at least the material and the dimensions of the workpiece to be heated can be input in the process controller and the process controller programmed so that it controls at least the contact force of the clamping jaws, the rotation number of the workpiece, and the induction in dependence of time according to a given program.

If the heated workpiece is not immediately further processed, then upon attainment of the desired temperature of the workpiece at least the rotation number of the workpiece can be lowered to a value at which the losses by heat radiation and heat conduction are approximately compensated. Alternatively, the magnetic induction can be lowered for the same purpose.

The direct-current magnetic field can be generated by means of at least one superconducting coil.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A method for induction heating of a metallic workpiece to a desired temperature, the method comprising:
clamping the workpiece between two clamping jaws adapted to be rotated about a common axis, wherein at least one of the clamping jaws is driven to rotate;
rotating the workpiece relative to a direct-current magnetic field permeating the workpiece about a rotation axis, wherein at least one of the clamping jaws is adapted to be actively displaced along or parallel to the rotation axis;
regulating a contact force of at least one of the clamping jaws; and
measuring as an actual value at least one mechanical parameter representative of the workpiece temperature and comparing the actual value with a desired value of the mechanical parameter as being representative of the desired temperature.

2. The method according to claim 1, wherein the induction heating is stopped when the actual value has attained the desired value.

3. The method according to claim 1, wherein:
the actual value of the representative mechanical parameter is measured as an electrical signal or converted to an electrical signal; and
the electrical signal value is compared with the value of an electrical signal corresponding to the desired value.

4. The method according to claim 1, wherein the actual value is measured continuously and stored.

5. The method according to claim 1, wherein the desired value representative of the desired temperature is determined on a reference workpiece that is heated inductively according to the same method, with its temperature and the corresponding actual value of the mechanical parameter being determined, and also the value of the mechanical parameter measured upon attainment of the desired temperature being treated as a desired value for all similar workpieces.

6. The method according to claim 1, wherein:
the workpiece possesses a thermal expansion parameter; and
the thermal expansion parameter of the workpiece is used as a representative mechanical parameter.

7. The method according to claim 6, wherein the thermal expansion is measured by a path-measuring means.

8. The method according to claim 7, wherein:
the workpiece includes a longest axis; and
the thermal expansion of the workpiece is measured along the longest axis of the workpiece.

9. The method according to claim 1, wherein the clamping jaws are formed of material having poor thermal conductivity.

10. The method according to claim 1, wherein the contact force is regulated in dependence upon temperature to a value corresponding to a surface pressure that is lower than a temperature-dependent surface pressure at which plastic deformation of the workpiece begins.

11. The method according to claim 1, wherein:
the contact force of the clamping jaws is produced utilizing hydraulic pressure, and
the value of the contact force is determined from the value of the hydraulic pressure.

12. The method according to claim 1, wherein the representative mechanical parameter is mechanical work supplied to the workpiece.

13. The method according to claim 12, wherein torque transmitted to the workpiece is measured continuously.

14. The method according to claim 12, wherein the mechanical work is calculated from rotation number, torque, and time.

15. The method according to claim 12, wherein the mechanical work is calculated from the time-integral of the time-dependent rotation number and the time-dependent torque.

16. The method according to claim 12, wherein the temperature determined from the mechanical work is used for a plausibility check of the temperature of the workpiece determined from the thermal expansion.

17. The method according to claim 1, wherein the reference values measured on the reference workpiece and the actual values of the mechanical parameter measured on the workpieces are continuously stored in a process computer operable to compare the actual values of the workpiece measured during the induction heating with the stored reference values and emits a signal representative of the actual temperature.

18. The method according to claim 17, wherein the reference values for workpieces of different dimensions and/or for workpieces of different materials are stored in the process computer in separate data files.

19. The method according to claim 17, wherein:
at least the material and the dimensions of the workpiece to be heated are input in the process computer; and
the process computer controls at least the contact force of the clamping jaws, the rotation number of the workpiece, and the induction in dependence upon time according to a pre-determined program.

20. The method according to claim 19, wherein, when the desired temperature of the workpiece is reached, at least the rotation number of the workpiece is lowered to a value at which the losses by heat radiation and heat conduction are approximately compensated.

21. The method according to claim 19, wherein when the desired temperature of the workpiece being reached, the magnetic induction is lowered to a value at which the losses by heat radiation and heat conduction are approximately compensated.

22. The method according to claim 1, wherein the direct-current magnetic field is generated by at least one superconducting coil.
